(19) United States
(12) Patent Application Publication
(10) Pub. No.: US 2012/0092361 A1
(43) Pub. Date: Apr. 19, 2012

(54) DISPLAY DEVICE

(75) Inventor: Kohji Saitoh, Osaka (JP)

(73) Assignee: SHARP KABUSHIKI KAISHA, Osaka-shi, Osaka (JP)

(21) Appl. No.: 13/378,371

(22) PCT Filed: Mar. 12, 2010
(86) PCT No.: PCT/JP2010/001803

§ 371 Date: Dec. 15, 2011

(30) Foreign Application Priority Data
Jun. 25, 2009 (JP) 2009-151259

(51) Int. Cl. G09G 3/36; G09G 5/02

(52) U.S. Cl. 345/589; 345/88; 345/102

(57) ABSTRACT

Three colors of light-emitting elements (3, 4, and 5) are connected in series via a single wire (made up of lines 7 and 8) so that a single electric current is applied. An area ratio of a opening part of each of pixels (15, 16, and 17) provided for the respective three colors and an area ratio of each of color filter layers (12, 13, and 14) for the respective pixels (15, 16, and 17) are set so that white light can be generated.

### TECHNICAL FIELD

The present invention relates to a display device including a backlight which has, as a light source, a light-emitting element, in particular, an LED (light emitting diode) element.

### BACKGROUND ART

In recent years, for example, a liquid crystal display device has rapidly spread instead of a cathode-ray tube (CRT). Such a liquid crystal display device is widely used in various electronic devices such as a television, a monitor, and a mobile phone, by taking advantage of features such as high definition, energy-saving, thin body, and lightweight.

Recently, there are increasing opportunities in which moving images, such as a TV program, is watched with the use of a portable device, such as a mobile phone, other than a television or a monitor. Such a portable device has also been developed to have higher degree of color reproducibility, in order to meet a demand for color purity at the same level as a television.

Conventionally, a pseudo-white LED has been used, as a light source of a backlight, in a device such as a small portable device or a medium or large sized television, in view of reduction in thickness and in weigh, etc.

However, the pseudo-white LED has a limitation in terms of high color reproducibility. In view of this, it has been demanded to use, instead of the pseudo-white LED, an LED group made up of different colors of LEDs, specifically, three colors (i.e., red (R), green (G), and blue (B)) of LEDs. However, according to the configuration employing such a conventional LED group, a complicated control is required for adjusting an electric current, which is applied to each of the red (R), green (G), and blue (B) LEDs. This causes a problem of high cost, because a high performance LED driver is required to carry out such a complicated control.

In view of the problem, a configuration has been conventionally proposed in which light sources are driven by a single power source so that performance/response and voltage adjustment are simplified.

For example, Patent Literature 1 discloses a configuration in which a plurality of LED elements, each of which emit light of R, G, or B, are mounted on a circuit board and a constant power supply voltage is applied to the LED elements of R, G, and B via corresponding wiring lines.

According to the configuration disclosed in Patent Literature 1, a reflecting plate 102 is provided on (i) a metal substrate having an insulating layer or (ii) a ceramic substrate 101; R-LED elements 106 (each of which has a peak falling under a wavelength range between 610 nm and 640 nm) are connected in series by a wiring line 103; G-LED elements 107 (each of which has a peak falling under a wavelength range between 510 nm and 540 nm) are connected in series by a wiring line 104; B-LED elements 108 (each of which has a peak falling under a wavelength range between 445 nm and 475 nm) are connected in series by a wiring line 105; and each package is sealed by transparent resin 109 (see FIG. 14). Here, six R-LED elements 106 are connected in series by the wiring line 103, four G-LED elements 107 are connected in series by the wiring line 104, and four B-LED elements 108 are connected in series by the wiring line 105.

According to the configuration, in order for the light source of the backlight to secure a necessary and sufficient electric current, a voltage of 2 V needs to be applied to each of the R-LED elements 106, a voltage of 3 V needs to be applied to each of the G-LED elements 107, and a voltage of 3V needs to be applied to each of the B-LED elements 108. Since the number of the R-LED elements 106 is six, the number of the G-LED elements 107 is four, and the number of the B-LED elements 108 is four, a voltage of 12 V is supplied from the power supply in order for a backlight 112 to secure sufficient light sources.

Alternatively, it is possible to double the numbers of the respective LED elements 106, 107, and 108 and to configure the power supply to supply a voltage of 24 V, accordingly.

According to the configuration, the R-LED elements 106 connected in series by the wiring line 103, the G-LED elements 107 connected in series by the wiring line 104, and the B-LED elements 108 connected in series by the wiring line 105 can be driven by a single power supply voltage.

In the circuit board 101, performances of the respective LED elements 106, 107, and 108 become uneven, because the LED elements 106, 107, and 108 have respective different current-voltage characteristics. In order to address this, a variable resistor 110 is provided to the wiring lines so as to regulate resistance of the whole wiring. The variable resistor 110 allows the LED elements 106, 107, and 108 to be driven by a constant power supply voltage supplied by a constant voltage supply 111. Patent Literature 1 discloses, alternatively, a configuration in which the variable resistor 110 is provided to each of the wiring lines 103, 104, and 105 so that the operation voltage can be regulated by resistance more accurately.

### CITATION LIST

### Patent Literature

### [Patent Literature 1]

Japanese Patent Application Publication Tokukai No. 2008-269947 A (Publication date: Nov. 6, 2008)

### SUMMARY OF INVENTION

### Technical Problem

According to the configuration disclosed in Patent Literature 1, however, in order for the light source of the backlight to secure a necessary and sufficient electric current, a necessary voltage is adjusted by altering the number of the LED elements 106, 107, and 108, each colored ones of which are connected in series via a corresponding one of the wiring lines 103, 104, and 105. Therefore, the number of the wiring lines 103, 104, and 105 cannot be reduced.

The configuration of Patent Literature 1 causes complicated wiring on a circuit board, such as an FPC (flexible printed circuit) or an FPCB (flexible printed circuit board), which is used in a backlight so that the LED elements 106, 107, and 108 are mounted thereon. Further, a width of such a circuit board tends to become large. This leads to increase in cost of the device.

Moreover, according to the configuration of Patent Literature 1, the voltage, which is necessary for the light source of the backlight to secure the necessary and sufficient electric current, is adjusted by changing the number of the LED elements 106, 107, and 108 and providing the variable resistor 110. In view of this, it is difficult for a liquid crystal display device, which includes the backlight of the Patent Literature 1, to easily generate desired white light (whiteness). However, Patent Literature 1 does not disclose at all a method for solving such a problem.

The present invention is accomplished in view of the problem, and its object is to provide a display device which can (i) generate desired white light (whiteness), (ii) simplify wiring on a circuit board, such as an FPC or an FPCB, which is used in a backlight so that the plurality of colors of light-emitting elements are mounted thereon, (iii) reduce a width of such a circuit board, and (iv) employ a widely used control circuit for controlling light-emitting element.

### Solution to Problem

In order to attain the object, a display device of the present invention, which displays an image by modulating an amount of transmitting light in accordance with an image signal, includes: a plurality of light-emitting element groups each made up of at least two colors of light-emitting elements so that white light is generated, the light-emitting element group serving as a light source of the display device; at least two color filter layers for the respective at least two colors; and at least two pixels provided for the respective at least two colors, each of the at least two pixels having an opening part, the at least two colors of light-emitting elements being connected in series so as to receive a single electric current via a wire, and (i) a first area ratio of the opening part of each of the at least two pixels and (ii) a second area ratio of each of the at least two color filter layers for the respective at least two pixels are set so that the white light is generated.

According to a conventional display device in which (i) color filter layers of different colors have identical areas and (ii) opening parts (through which light emitted from a backlight passes) of respective pixels, which correspond to the respective colors of color filter layers, have identical areas, for example, a red LED, a green LED, and a blue LED, which constitute a light-emitting element group, have respective different current-luminance characteristics. Therefore, in order to obtain desired white light (whiteness), it has been necessary to provide three wires for applying separate electric currents to the respective colors of LEDs and to provide a special LED control circuit which separately controls the three wires.

On the other hand, according to the configuration of the present invention, the at least two colors of the light-emitting elements are connected in series via a wire, more specifically a single wire, so that a single electric current is applied to the at least two colors of the light-emitting elements. As such, it is possible to reduce the number of the wire, as compared with the conventional configuration.

With the configuration of the present invention, it is possible to prevent (i) complicated wiring on a circuit board, such as an FPC or an FPCB, which is used in a backlight so that a plurality of colors of light-emitting elements are mounted thereon and (ii) an increase in width of such a circuit board.

According to the configuration of the present invention, it is possible to use (i) a widely used control circuit which controls a single electric current or (ii) a control circuit which controls two different electric currents. This allows a reduction in cost.

According to the configuration of the present invention, the common electric current is applied to the at least two colors of the light-emitting elements connected in series. With the configuration, it is not possible to apply different electric currents to the respective at least two colors of the light-emitting elements.

In view of this, (i) the first area ratio of the opening part of each of the at least two pixels, which are provided for the respective at least two colors, and (ii) the second area ratio of each of the at least two color filter layers for the respective at least two pixels are set so that the white light is generated.

That is, instead of separately controlling electric currents applied to the respective light-emitting elements, (i) the first area ratio of the opening part of each of the at least two pixels, which are provided for the respective at least two colors, and (ii) the second area ratio of each of the at least two color filter layers, which correspond to the at least two pixels, are modified so that the desired white light is generated.

According to the configuration of the present invention, as above described, it is possible to (i) obtain the desired white light (whiteness), (ii) simplify the wiring on the circuit board, such as an FPC or an FPCB, which is used in a backlight so that a plurality of colors of light-emitting elements are mounted thereon, (iii) reduce a width of the circuit board, and (iv) employ the widely used control circuit for controlling the light-emitting elements. It is therefore possible to achieve cost reduction.

Note that a typical combination of colors of the light-emitting elements for generating white light is a combination of R, G, and B. However, the present invention is not limited to the combination, and therefore any combination of colors can be used, provided that white light can be obtained by the combination of the colors.

In order to attain the object, a display device of the present invention, which displays an image by modulating an amount of transmitting light in accordance with an image signal, includes: a plurality of light-emitting element groups each made up of at least two colors of light-emitting elements so that white light is generated, the light-emitting element group serving as a light source of the display device; at least two color filter layers for the respective at least two colors; and at least two pixels provided for the respective at least two colors, each of the at least two pixels having an opening part, the at least two colors of light-emitting elements being connected in series so as to receive a single electric current via a wire, and (i) a first area ratio of the opening part of each of the at least two pixels and (ii) a thickness of each of the at least two color filter layers for the respective at least two pixels are set so that the white light is generated.

According to the configuration of the present invention, the common electric current is applied to the at least two colors of the light-emitting elements connected in series. With the configuration, it is not possible to apply different electric currents to the respective at least two colors of the light-emitting elements.

In view of this, (i) the first area ratio of the opening part of each of the at least two pixels, which are provided for the at least two colors, and (ii) the thickness of each of the at least two color filter layers for the respective at least two pixels are set so that the desired white light is generated.

That is, instead of separately controlling electric currents applied to the respective light-emitting elements, (i) the first area ratio of the opening part of each of the at least two pixels, which are provided for the respective at least two colors, and (ii) the thickness of each of the at least two color filter layers for the respective at least two pixels are modified so that the desired white light is generated.

The configuration also brings about the above described effects of the present invention.

In order to attain the object, a display device of the present invention, which displays an image by modulating an amount of transmitting light in accordance with an image signal, includes: a plurality of light-emitting element groups each made up of at least two colors of light-emitting elements so that white light is generated, the light-emitting element group serving as a light source of the display device; at least two color filter layers for the respective at least two colors; and at least two pixels provided for the respective at least two colors, each of the at least two pixels having an opening part, the at least two colors of light-emitting elements being connected in series so as to receive a single electric current via a wire, and (i) a first area ratio of the opening part of each of the at least two pixels and (ii) a second area ratio of and a thickness of each of the at least two color filter layers for the respective at least two pixels are set so that the white light is generated.

According to the configuration of the present invention, the common electric current is applied to the at least two colors of the light-emitting elements connected in series. With the configuration, it is not possible to apply different electric currents to the respective at least two colors of the light-emitting elements.

In view of this, (i) the first area ratio of the opening part of each of the at least two pixels, which are provided for the respective at least two colors, and (ii) the second area ratio and the thickness of each of the at least two color filter layers for the respective at least two pixels are set so that the desired white light is generated.

That is, instead of separately controlling electric currents applied to the respective light-emitting elements, (i) the first area ratio of the opening part of each of the at least two pixels, which are provided for the respective at least two colors, and (ii) the second area ratio and the thickness of each of the at least two color filter layers, which correspond to the respective at least two pixels, are modified so that the desired white light is generated.

The configuration also brings about the above described effects of the present invention. According to the configuration, both the area ratio and the thickness of each of the at least two color filter layers are adjusted. This allow the desired white light to be obtained by adjusting the area ratio and the thickness to a smaller degree, as compared with the configuration in which only one of the area ratio and the thickness is adjusted. It is therefore possible to provide the display device which has high productivity.

### ADVANTAGEOUS EFFECTS OF INVENTION

According to the display device of the present invention, as described above, at least two colors of light-emitting elements being connected in series so as to receive a single electric current via a wire, and (i) a first area ratio of the opening part of each of the at least two pixels, which are provided for the respective at least two colors, and (ii) a second area ratio of each of the at least two color filter layers for the respective at least two pixels are set so that the white light is generated.

According to the display device of the present invention, as described above, the at least two colors of light-emitting elements being connected in series so as to receive a single electric current via a wire, and (i) a first area ratio of the opening part of each of the at least two pixels, which are provided for the respective at least two colors, and (ii) a thickness of each of the at least two color filter layers for the respective at least two pixels are set so that the white light is generated.

According to the display device of the present invention, as described above, the at least two colors of light-emitting elements being connected in series so as to receive a single electric current via a wire, and (i) a first area ratio of the opening part of each of the at least two pixels, which are provided for the respective at least two colors, and (ii) a second area ratio of and a thickness of each of the at least two color filter layers for the respective at least two pixels are set so that the white light is generated.

With the configuration, it is possible to (i) obtain the desired white light (whiteness), (ii) simplify the wiring on the circuit board, such as an FPC or an FPCB, which is used in a backlight so that a plurality of colors of light-emitting elements are mounted thereon, (iii) reduce a width of the circuit board, and (iv) employ the widely used control circuit for controlling the light-emitting elements. It is therefore possible to achieve cost reduction.

### BRIEF DESCRIPTION OF DRAWINGS

FIG. 1

(a) of FIG. 1 illustrates a schematic configuration of a liquid crystal display device in accordance with an embodiment of the present invention, and (b) of FIG. 1 illustrates a schematic configuration of a conventional liquid crystal display device.

FIG. 2

FIG. 2 is a block diagram illustrating a schematic configuration of the liquid crystal display device in accordance with the embodiment of the present invention.

FIG. 3

FIG. 3 is a view illustrating an FPCB on which LED groups are provided in the liquid crystal display device in which an electrostatic protection circuit is provided, in accordance with the embodiment of the present invention.

FIG. 4

FIG. 4 is an x-y chromaticity diagram illustrating a preferable range of white light (whiteness) in the liquid crystal display device in accordance with the embodiment of the present invention.

FIG. 5

FIG. 5 is a block diagram illustrating a schematic configuration of a liquid crystal display device in accordance with another embodiment of the present invention.

FIG. 6

FIG. 6 is a schematic view illustrating (i) a cross sectional configuration of a liquid crystal display panel included in the liquid crystal display device shown in FIG. 5 and (ii) a configuration of the LED group.

FIG. 7

FIG. 7 is view illustrating an FPCB on which LED groups are provided in the liquid crystal display device in which electrostatic protection circuits are provided, in accordance with another embodiment of the present invention.

FIG. 8

FIG. 8 is a block diagram illustrating a schematic configuration of a liquid crystal display device in accordance with yet another embodiment of the present invention.

FIG. 9

FIG. 9 is a schematic view illustrating (i) a cross sectional configuration of a liquid crystal display panel included in the liquid crystal display device shown in FIG. 8 and (ii) a configuration of the LED group.

FIG. 10

FIG. 10 is view illustrating an FPCB on which LED groups are provided in the liquid crystal display device in which electrostatic protection circuits are provided, in accordance with yet another embodiment of the present invention.

FIG. 11

FIG. 11 is a block diagram illustrating a schematic configuration of a liquid crystal display device in accordance with still another embodiment of the present invention.

FIG. 12

FIG. 12 is a schematic view illustrating (i) a cross sectional configuration of a liquid crystal display panel included in the liquid crystal display device shown in FIG. 11 and (ii) a configuration of the LED group.

FIG. 13

FIG. 13 is view illustrating an FPCB on which LED groups are provided in the liquid crystal display device in which electrostatic protection circuits are provided, in accordance with still another embodiment of the present invention.

FIG. 14

FIG. 14 is view illustrating a configuration of a backlight provided in a conventional liquid crystal display device.

### DESCRIPTION OF EMBODIMENTS

The following describes details of embodiments of the present invention, with reference to drawings. Note, however, that the descriptions of dimensions, materials, and shapes of constituent members, and their relative locations etc. in the embodiments merely exemplify an embodiment of the present invention, and therefore should not be interpreted as limiting the scope of the invention only to them.

A display device of an embodiment in accordance with the present invention is capable of obtaining desired white light (whiteness). Further, the display device of the present embodiment is capable of cost reduction, by simplifying wiring on a circuit board (such as an FPC or an FPCB used in a backlight) onto which a plurality of colors of light-emitting elements are mounted and (ii) by reducing a width of the circuit board.

The following embodiments are the premised on a liquid crystal display device, which includes a side-light type illumination device (also called an edge-light type illumination device), for use mainly in medium and small sized electronic devices such as a mobile phone and a laptop computer. However, the embodiments are not limited to such a liquid crystal display device. It is of course possible to apply the embodiments to, for example, a liquid crystal display device including an illumination device, such as of a direct type, a tiled type, or a tandem type, employing a light emitting diode (hereinafter, referred to as “LED”) which exemplifies the light-emitting element.

### Embodiment 1

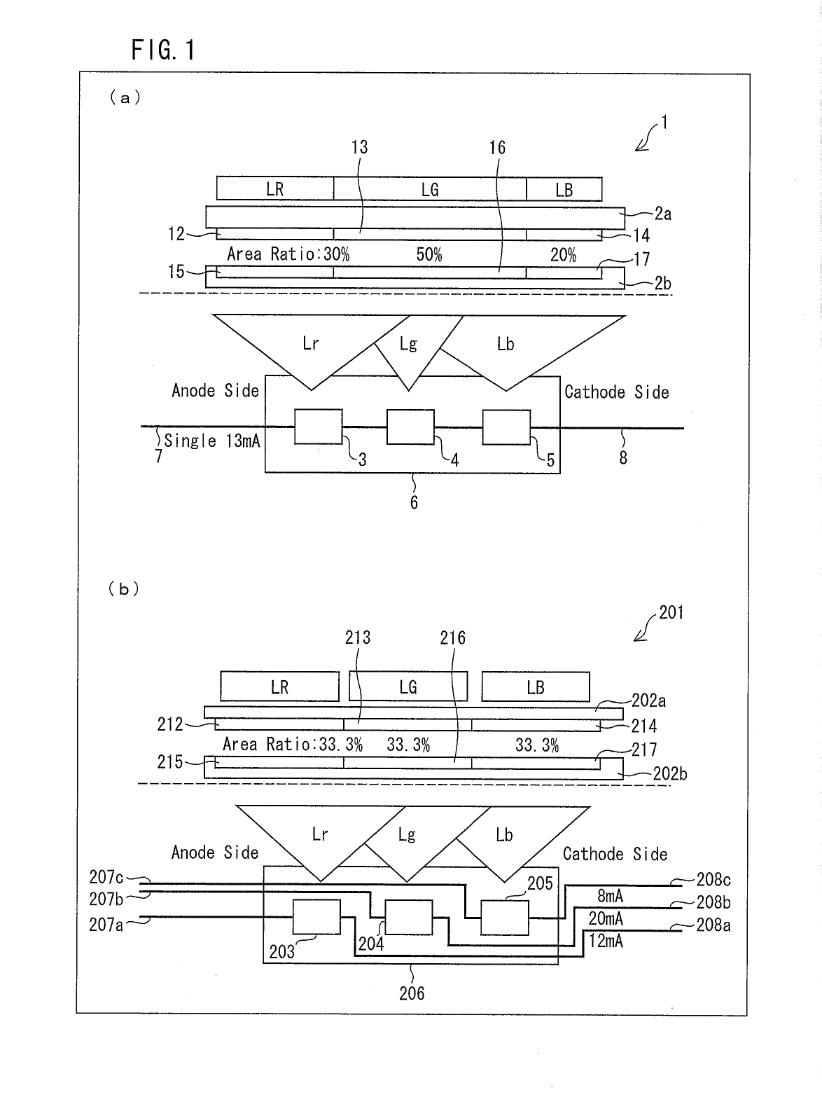

The following describes a liquid crystal display device 1 of an embodiment in accordance with the present invention, with reference to FIGS. 1 through 3.

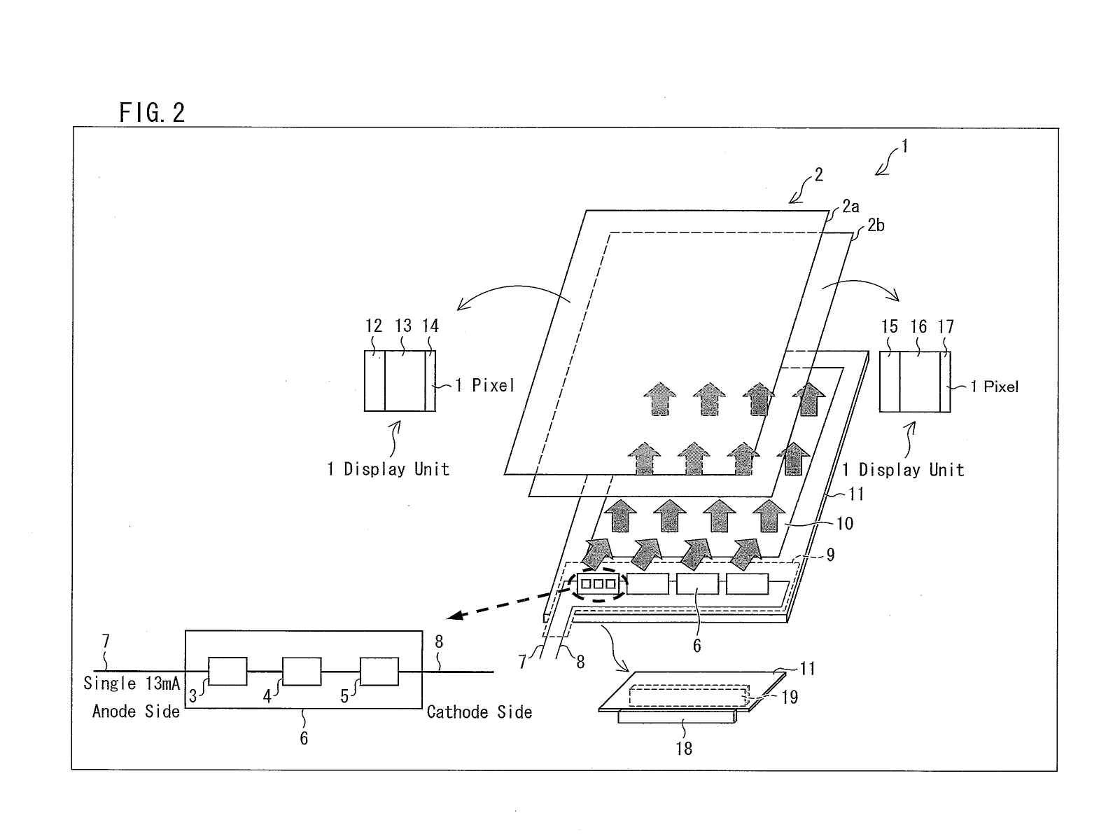

FIG. 2 is a block diagram illustrating a schematic configuration of the liquid crystal display device 1 in accordance with the embodiment of the present invention.

The liquid crystal display device 1 includes a liquid crystal display panel 2 and a backlight unit which backlights the liquid crystal display panel 2 (see FIG. 2).

The backlight unit includes, as light sources, a plurality of LED groups 6 each of which is made up of a red LED 3, a green LED 4, and a blue LED 5. The LEDs 3, 4, and 5 each emit light which spreads over the entire backlight unit via a light guide plate 10 so as to uniformly irradiate the liquid crystal display panel 2 with the light.

The LED group 6, which is made up of combined three-color LEDs 3, 4, and 5, allows the light guide plate 10 to emit white light.

Note that the present embodiment employs LED groups 6 of a side-emitting type in each of which the LEDs 3, 4, and 5 are molded in a single package. This allows the liquid crystal display device 1 to have a wide color reproduction range.

Note that the present embodiment employs the LED groups 6 each made up of the red LED 3, the green LED 4, and the blue LED 5. However, the present embodiment is not limited to this, but any combination of colors can be employed provided that white light can be generated by the combination of colors.

Moreover, the present embodiment employs, as the liquid crystal display panel 2, a transmissive liquid crystal display panel which carries out a display by transmitting light emitted from the backlight unit.

According to the liquid crystal display panel 2, each of display units is made up of three pixels indicating respective of red, green, and blue (see FIG. 2). The display units are provided over an entire face of the liquid crystal display panel 2.

The liquid crystal display panel 2 includes (i) a color filter substrate 2a, (ii) a TFT substrate 2b which faces the color filter substrate 2a and has TFTs (thin film transistors; not illustrated) provided for the respective pixels, and (iii) a liquid crystal layer which is sealed between the substrates 2a and 2b with a sealing material.

Each of display units of the color filter substrate 2a is made up of a red color filter layer 12, a green color filter layer 13, and a blue color filter layer 14. A black matrix (not illustrated) is provided between any adjacent two of the color filter layers 12, 13, and 14.

On the other hand, each of display units of the TFT substrate 2b is made up of pixels 15, 16, and 17. Note that the pixels 15, 16, and 17 each are provided so as to have an opening area (through which light emitted from the backlight unit is transmitted in each of the pixels 15, 16, and 17) which is slightly smaller than a corresponding one of the color filter layers 12, 13, and 14.

Note that a non-opening part (not illustrated), such as wiring part, of each of the pixels 15, 16, and 17 is masked by the black matrix.

When the color filter substrate 2a and the TFT substrate 2b are combined, an alignment is precisely carried out so that the display units of the color filter substrate 2a completely coincide with the respective display units of the TFT substrate 2b.

According to the liquid crystal display device 1, it is preferable that area ratios (i.e., parameters) of the respective color filter layers 12, 13, and 14 are identical to area ratios (i.e., parameters) of respective opening parts of the pixels 15, 16, and 17.

With the configuration, it is possible to simplify the configuration of the pixels 15, 16, and 17 and the configuration of the color filter layers 12, 13, and 14. It is further possible to change, while facilitating the design of area ratios, an amount of each colored light (i.e., an amount of transmitting light) emitted from the liquid crystal display device 1.

According to the present embodiment, the color filter layers 12, 13, and 14 are provided in the color filter substrate 2a. However, the present embodiment is not limited to this, but a COA (color filter on array) configuration can be employed in which the color filter layers 12, 13, and 14 are provided on the TFT substrate 2b side.

According to each of the LED groups 6 in the liquid crystal display device 1 of the present embodiment, all the LEDs 3, 4, and 5 are connected, in this order, in series so that a common electric current (i.e., a single electric current) is applied to the LEDs 3, 4, and 5, via electric current supply lines 7 and 8 (see FIG. 2).

Note that (i) the electric current supply line 7 is provided so as to be connected to the anode of the LED 3 and (ii) the current supply line 8 is provided so as to be connected to the cathode of the LED 5.

According to the configuration, only the current supply lines 7 and 8 are needed so as to apply a common electric current (e.g., an electric current of 13 mA) to the LEDs 3, 4, and 5 constituting the LED group 6. This makes it possible to (i) provide simplest wiring for an FPCB 9 on which the LED group 6 is provided and (ii) provide the FPCB 9 having a narrowest width. It is therefore possible to enlarge a display area of the liquid crystal display device 1 and to reduce cost of the liquid crystal display device 1.

According to the configuration, since the identical electric current (e.g., an electric current of 13 mA) is applied to all of the LEDs 3, 4, and 5 constituting the LED group 6, the LEDs 3, 4, and 5 are not controlled independently.

In view of the circumstances, according to the present embodiment, (i) the area ratio of the color filter layers 12, 13, and 14 and (ii) the area ratio of the opening parts of the respective pixels 15, 16, and 17, which correspond to the color filter layers 12, 13, and 14, respectively, are set so that desired white light can be generated (see FIG. 2). In other words, (i) the color filter layers 12, 13, and 14 are configured to have respective different areas and (ii) the pixels 15, 16, and 17 are configured to have respective different areas, in accordance with amounts of respective colors of light emitted by the LEDs 3, 4, and 5. As such, it is possible to generate desired white light (whiteness).

According to the configuration illustrated in FIG. 2, each of the green color filter layer 13 and the corresponding pixel 16 is configured to have an area larger than that of each of the other colors (i.e., red and blue) in one (1) display unit so that the amount of green light, whose luminous efficiency is relatively low, is increased. On the other hand, each of the blue color filter layer 14 and the corresponding pixel 17 is configured to have an area smaller than that of each of the other colors (i.e., red and green) pixels in the one (1) display unit so that the amount of blue light, whose luminous efficiency is relatively high, is decreased.

According to the present embodiment, aperture ratios of the respective pixels 15, 16, and 17, i.e., ratios of the opening parts to the respective pixels 15, 16, and 17 are set to be identical with each other. It follows that, as the pixels 15, 16, and 17 become larger, the opening parts of the respective pixels 15, 16, and 17 become larger.

With the configuration, it is thus possible to design the opening parts of the respective pixels 15, 16, and 17 to have respective different areas by designing the pixels 15, 16, and 17 to have respective different areas.

Note that, although the present embodiment is configured so that the pixels 15, 16, and 17 have the identical aperture ratios, the present embodiment is not limited to this. Therefore, the pixels 15, 16, and 17 can be configured to have respective different aperture ratios.

The following further specifically describes, with reference to FIG. 1, how to adjust light amounts of respective colors, light amounts are emitted from the liquid crystal display device 1, in accordance with light amounts emitted by the respective LEDs 3, 4, and 5.

(a) of FIG. 1 is a schematic view illustrating (i) a cross section of the liquid crystal display panel 2 provided in the liquid crystal display device 1 illustrated in FIG. 2 and (ii) a configuration of the LED group 6 in the liquid crystal display panel 2. (b) of FIG. 1 is a schematic view illustrating (i) a cross section of a liquid crystal display panel included in a conventional liquid crystal display device and (ii) a configuration of an LED group in the liquid crystal display panel.

In a conventional liquid crystal display device 201, color filter layers 212, 213, and 214 have identical area ratios (i.e., R:33.3%, G:33.3%, and B:33.3%), and opening parts of respective pixels 215, 216, and 217 also have identical area ratios (i.e., R:33.3%, G:33.3%, and B:33.3%) (see (b) of FIG. 1).

The conventional liquid crystal display device 201 has an LED group 206 made up of LEDs 203, 204, and 205, which emit red light, green light, and blue light, respectively, and have respective different current-luminance characteristics. According to such a conventional configuration, in order for the conventional liquid crystal display device 201 to obtain a desired whiteness, it has been necessary to provide three wires, i.e., a wire made up of current supply lines 207a and 208a, a wire made up of current supply lines 207b and 208b, and a wire made up of current supply lines 207c and 208c so as to control electric currents flowing through the respective LEDs 203, 204, and 205.

In practice, in order for the conventional liquid crystal display device 201 to obtain a whiteness of (x, y)=(0.313, 0.329), it is necessary to apply an electric current of 12 mA to the red LED 203, an electric current of 20 mA to the green LED 204, and an electric current of 8 mA to the blue LED 205. As such, it is necessary to prepare the three wires, i.e., the wire made up of the current supply lines 207a and 208a, the wire made up of the current supply lines 207b and 208b, and the wire made up of the current supply lines 207c and 208c.

On the other hand, according to the liquid crystal display device 1 of the present embodiment (see (a) of FIG. 1), a common electric current (e.g., an electric current of 13 mA) is applied, for example, via the single wire made up of the current supply lines 7 and 8, to the LEDs 3, 4, and 5 which constitute the LED group 6.

Note that the color filter layers 12, 13, and 14 and the pixels 15, 16, and 17, respectively corresponding to the color filter layers 12, 13, and 14 (see (a) of FIG. 1), have assumptions identical to those of the counterparts illustrated in (b) of FIG. 1 (i.e., the color filter layers 212, 213, and 214 and the pixels 215, 216, and 217), except for their areas.

Note that reference symbols “Lr”, “Lg”, and “Lb” in (a) and (b) of FIG. 1 indicate red light, green light, and blue light, respectively, emitted by the respective LEDs. Reference symbols “LR”, “LG”, and “LB” in (a) and (b) of FIG. 1 indicate red light, green light, and blue light, respectively, emitted from the liquid crystal display device.

According to the liquid crystal display device 1 of the present embodiment, it is preferable that the electric current, which is applied to each of the LEDs 3, 4, and 5 via the wire made up of the current supply lines 7 and 8, is an electric current (13 mA) which is substantially an average of three electric currents (red: 12 mA, green: 20 mA, and blue: 8 mA), which are applied to the respective LEDs 203, 204, and 205, in view of the fact that a desired whiteness (x, y) of the conventional liquid crystal display device 201 is (0.313, 0.329).

With the configuration, it is possible to obtain the desired white light (whiteness) without significantly altering the configuration (such as one illustrated in (b) of FIG. 1) in which the opening parts have identical area ratios and the color filter layers have identical area ratios.

With regard to the red light, the electric current (13 mA), which is applied to the red LED 3 provided in the liquid crystal display device 1, is larger than the electric current (12 mA) which is applied to the red LED 203 provided in the conventional liquid crystal display device 201. In order to address this, the red color filter layer 12 and the pixel 15 in the liquid crystal display device 1 are configured such that an amount of the red light is decreased (i.e., the area ratio is decreased from 33.3% to 30%).

With regard to the green light, the electric current (13 mA), which is applied to the green LED 4 provided in the liquid crystal display device 1, is smaller than the electric current (20 mA) which is applied to the green LED 204 provided in the conventional liquid crystal display device 201. In order to address this, the green color filter layer 13 and the pixel 16 in the liquid crystal display device 1 are configured such that an amount of the green light is increased (i.e., the area ratio is increased from 33.3% to 50%). With regard to the blue light, the electric current (13 mA), which is applied to the blue LED 5 provided in the liquid crystal display device 1, is larger than the electric current (8 mA) which is applied to the blue LED 205 provided in the conventional liquid crystal display device 201. In order to address this, the blue color filter layer 14 and the pixel 17 in the liquid crystal display device 1 are configured such that an amount of the blue light is decreased (i.e., the area ratio is decreased from 33.3% to 20%). This allows the liquid crystal display device 1 to achieve the desired whiteness ((x, y)=(0.313, 0.329)).

According to the present embodiment, the “area ratio” of each of the color filter layers 12, 13, and 14 is defined as a ratio of an area of the each of the color filter layers 12, 13, and 14 to a sum (i.e., 100%) of the areas of the color filter layers 12, 13, and 14 in one (1) display unit. The “area ratio” of the opening part of each of the pixels 15, 16, and 17, which correspond to the color filter layers 12, 13, and 14, respectively, is defined as a ratio of an area of the opening part of the each of the pixels 15, 16, and 17 to a sum (i.e., 100%) of the areas of the opening parts in one (1) display unit. Note that, according to the present embodiment, the “area ratios” are obtained based on the assumption that the color filter layers 12, 13, and 14 have respective areas identical to the respective areas of the respective opening parts of the respective pixels 15, 16, and 17.

According to the present embodiment, the color filter layers 12, 13, and 14 are set to have the areas substantially identical to those of the respective opening parts of the respective pixels 15, 16, and 17 (specifically, the opening parts of the respective pixels 15, 16, and 17 are set to have respective areas slightly smaller than those of the respective color filter layers 12, 13, and 14, as described above). Note, however, that the present embodiment is not limited to this, provided that the areas of the respective color filter layers 12, 13, and 14 and the areas of the respective opening parts of the pixels 15, 16, and 17 are set so that the desired whiteness can be achieved.

The liquid crystal display device 1 includes an LED control circuit 19 which controls the LEDs 3, 4, and 5 (see FIG. 2).

Conventionally, it has been necessary to provide a special LED control circuit which controls the LEDs 3, 4, and 5 separately by applying three separate electric currents to the respective LEDs 3, 4, and 5. On the other hand, the configuration of the present embodiment employs a general-purpose LED control circuit 19 which can merely control a single electric current. It is therefore possible to reduce cost of the liquid crystal display device 1.

According to the present embodiment, the LED control circuit 19 and a connector 18 (later described) are provided on a back surface of a substrate 11, which supports (i) the FPCB 9 onto which the LED groups 6 are mounted and (ii) the light guide plate 10 so as to reduce an area of the outer frame of the liquid crystal display device 1. Note, however, that the present embodiment is not limited to the arrangement. Namely, the LED control circuit 19 and the connector 18 can be provided not on a side of the liquid crystal display device 1 but on a side of an electronic device such as a mobile phone or a DSC in which the liquid crystal display device 1 is to be provided.

In the liquid crystal display device 1, the current supply lines 7 and 8 have respective terminals which are electrically connected with the LED control circuit 19 via the connector 18 on the FPCB 9.

The liquid crystal display device 1 employs the connector 18 which has the fewer number of terminals arranged at greater intervals, as compared with the conventional liquid crystal device. This allows a reduction in cost and an improvement in workability.

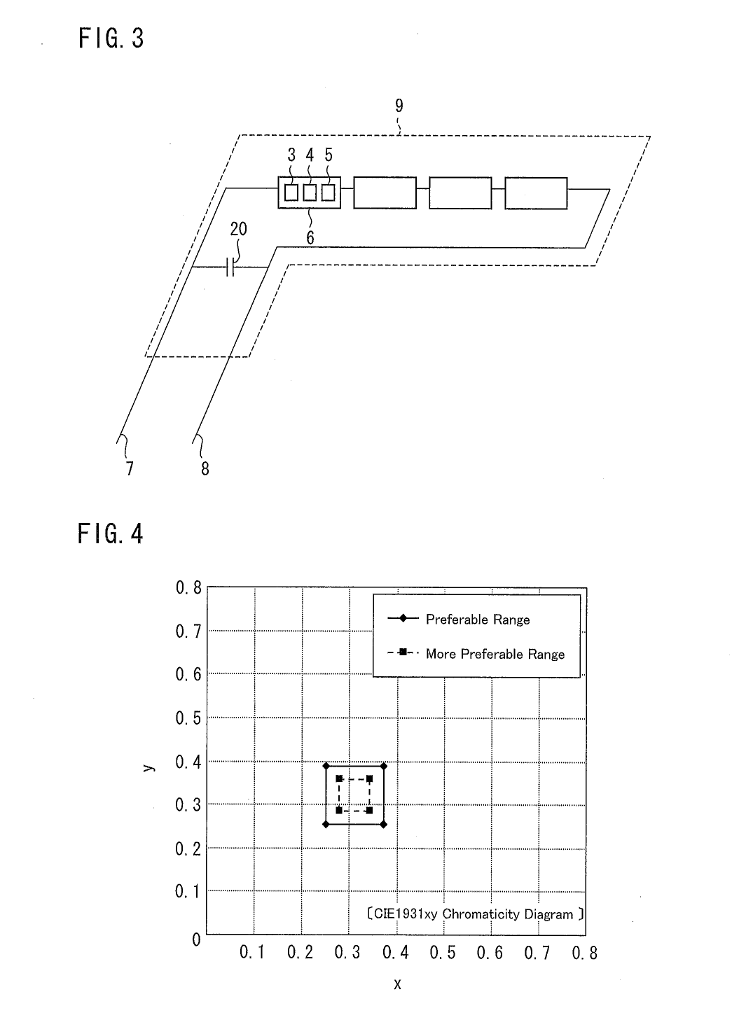

In the liquid crystal display device 1, it is preferable that the LED group 6 is provided on the FPCB 9, which has flexibility (see FIG. 3).

In general, medium and small sized liquid crystal display devices have a spatial limitation. As such, a degree of freedom is improved in arrangement of constituent members of such medium and small sized liquid crystal display devices by using a flexible printed circuit board.

With the configuration of the liquid crystal display device 1, it is possible to simplify wiring on the FPCB 9 and reduce a width of the FPCB 9. This allows a reduction in area of an outer frame which is a non-display area, in particular, in medium and small sized liquid crystal display devices. As such, it is possible to provide a compact liquid crystal display device 1.

FIG. 3 illustrates the FPCB 9 on which the LED groups 6 are provided in the liquid crystal display device 1 in which a capacitor constituting an electrostatic protection circuit 20 is provided.

According to the present embodiment, a protection capacitor is provided for preventing ESD (electrostatic discharge), as the electrostatic protection circuit 20, between the current supply line 7 (i.e., a current inflow side) and the current supply line 8 (i.e., a current outflow side). Note, however, that the present embodiment is not limited to this, and therefore an appropriate combination of known methods can be used.

Note that (i) the current supply line 7 is provided so as to be connected to the anode of the LED 3 and (ii) the current supply line 8 is provided so as to be connected to the cathode of the LED 5.

With the configuration, it is possible to prevent the LEDs 3, 4, and 5 from being broken by externally applied static electricity or a noise current. Moreover, the number of the necessary electrostatic protection circuit 20 is only one (1), and it is therefore possible to achieve cost reduction and improvement in productivity, as compared with the prior art.

According to the present embodiment, four LED groups 6 are connected in series (see FIGS. 2 and 3). Note, however, that the present embodiment is not limited to this, and the LED groups 6 can therefore be connected in parallel. Moreover, the number of the LED groups 6 is not limited to a particular one.

Note that the desired white light (whiteness) can be generated by the liquid crystal display device 1 by using the following method, instead of using the method above described. That is, the desired white light can be generated by setting (i) the area ratios of the opening parts of the respective pixels 15, 16, and 17, which correspond to the color filter layers 12, 13, and 14, respectively, and (ii) thicknesses (parameters) of the respective color filter layers 12, 13, and 14, instead of changing the area ratios of the respective color filter layers 12, 13, and 14. In other words, the desired white light (whiteness) can be obtained by setting, in accordance with light amounts of respective colors which are emitted by the respective LEDs 3, 4, and 5 when generating white light, (i) the opening parts of the respective pixels 15, 16, and 17 to have respective different areas and (ii) the color filter layers 12, 13, and 14 to have respective different thicknesses.

Alternatively, the desired white light can be generated by adjusting the thicknesses of the respective color filter layers 12, 13, and 14, even in a case where the liquid crystal display device 1 is configured so that (i) the opening parts of the respective pixels 215, 216, and 217, which correspond to the color filter layers 212, 213, and 214, respectively, have identical area ratios and (ii) the color filter layers 212, 213, and 214 have identical area ratios (see (b) of FIG. 1).

Alternatively, the desired white light can be generated by setting (i) an area ratio of the opening part of each of the pixels 15, 16, and 17 which correspond to the color filter layers 12, 13, and 14, respectively, and (ii) an area ratio of and a thickness of each of the color filter layers 12, 13, and 14.

According to the configuration, both the area ratio of and thickness of each of the color filter layers 12, 13, and 14 are adjusted. This allows the desired white light to be generated by adjusting the area ratio and the thickness to a smaller degree, as compared with the configuration in which only one of the area ratio and the thickness is adjusted. It is therefore possible to improve productivity.

According to the methods above described, at least the thicknesses of the respective color filter layers 12, 13, and 14 are adjusted so that the desired white light can be generated.

In order to increase the amount of green light which has relatively low luminous efficiency in the liquid crystal display device 1, the green color filter layer 13 is made to be relatively thinner than each of the color filter layers 12 and 14, for example. With the configuration, the desired white light can be generated.

On the other hand, in order to decrease the amount of blue light which has relatively high luminous efficiency, the blue color filter layer 14 of the liquid crystal display device 1 is made to be relatively thicker than each of the color filter layers 12 and 13. With the configuration, the desired white light can be generated.

FIG. 4 is an x-y chromaticity diagram (i.e., a chromaticity diagram of the CIE 1931 color system standardized by the International Commission on Illumination) illustrating a preferable range of white light generated by the liquid crystal display device 1.

According to the configurations of the present embodiment, as early described, (i) the area ratio of the opening part of each of the pixels 15, 16, and 17, which correspond to the color filter layers 12, 13, and 14, respectively, and (ii) the area ratio of and/or the thickness of each of the color filter layers 12, 13, and 14 are set so that the desired white light (whiteness) can be generated.

According to the present embodiment, a preferable range of the white light (whiteness) falls within a range (see FIG. 4) specified by four points which are indicated by respective coordinates (x, y)=(0.25, 0.256), (x, y)=(0.25, 0.389), (x, y)=(0.373, 0.389), and (x, y)=(0.373, 0.256).

A more preferable range of the white light (whiteness) falls within a range (see FIG. 4) specified by four points which are indicated by respective coordinates (x, y)=(0.28, 0.286), (x, y)=(0.28, 0.359), (x, y)=(0.343, 0.359), and (x, y)=(0.343, 0.286).

Each of Embodiments 2 though 4 below discusses a case where two of the LEDs 3, 4, and 5, which constitute the LED group 6, are connected in series via a wire (made up of current supply lines) so that a common electric current is applied to the two of the LEDs 3, 4, and 5.

### Embodiment 2

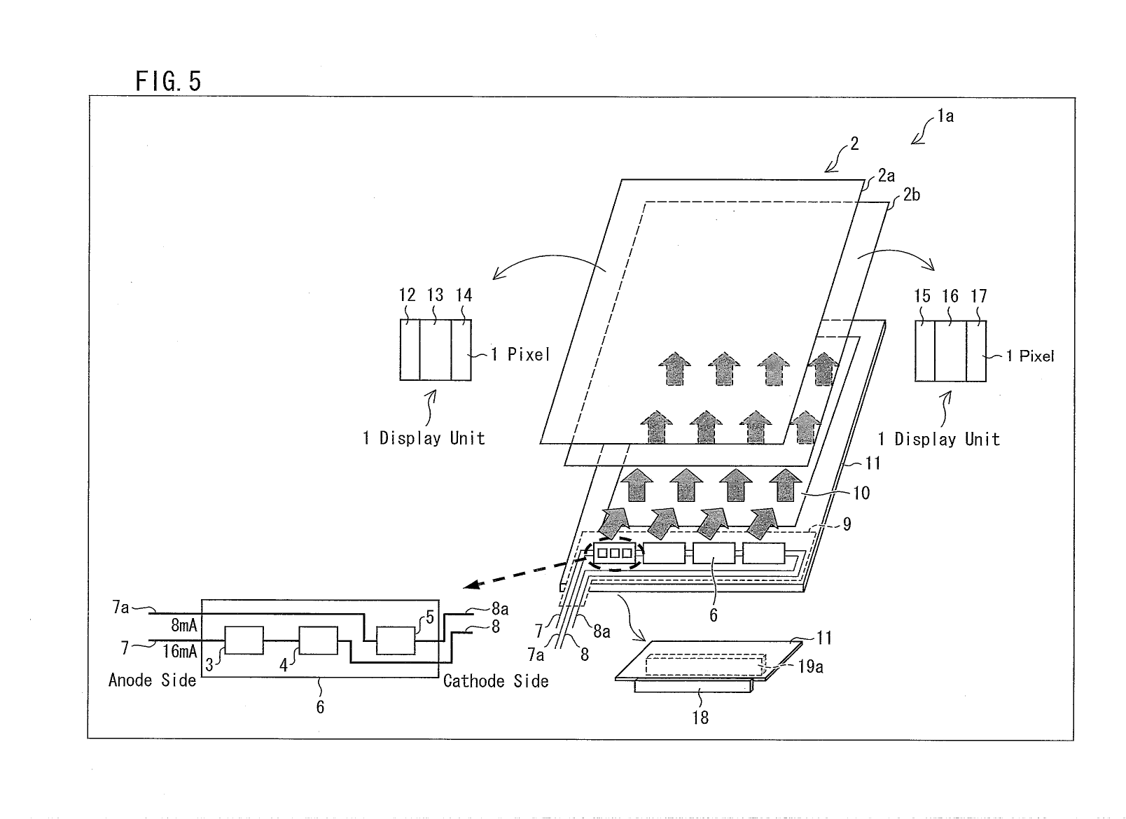

The following describes Embodiment 2 of the present invention, with reference to FIGS. 5 through 7. In Embodiment 2, two of LEDs 3, 4, and 5, which constitute an LED group 6, are connected in series. Specifically, the red LED 3 and the green LED 4 are connected in series by a wire, which is made up of current supply lines 7 and 8, so that a common electric current is applied to the LEDs 3 and 4. The other arrangements in Embodiment 2 are identical to those in Embodiment 1. For convenience, the same reference numerals are given to constituent members having functions identical to those described in Embodiment 1 with reference to the drawings, and descriptions of such constituent members are omitted.

FIG. 5 is a block diagram illustrating a schematic configuration of a liquid crystal display device 1a in accordance with the present embodiment.

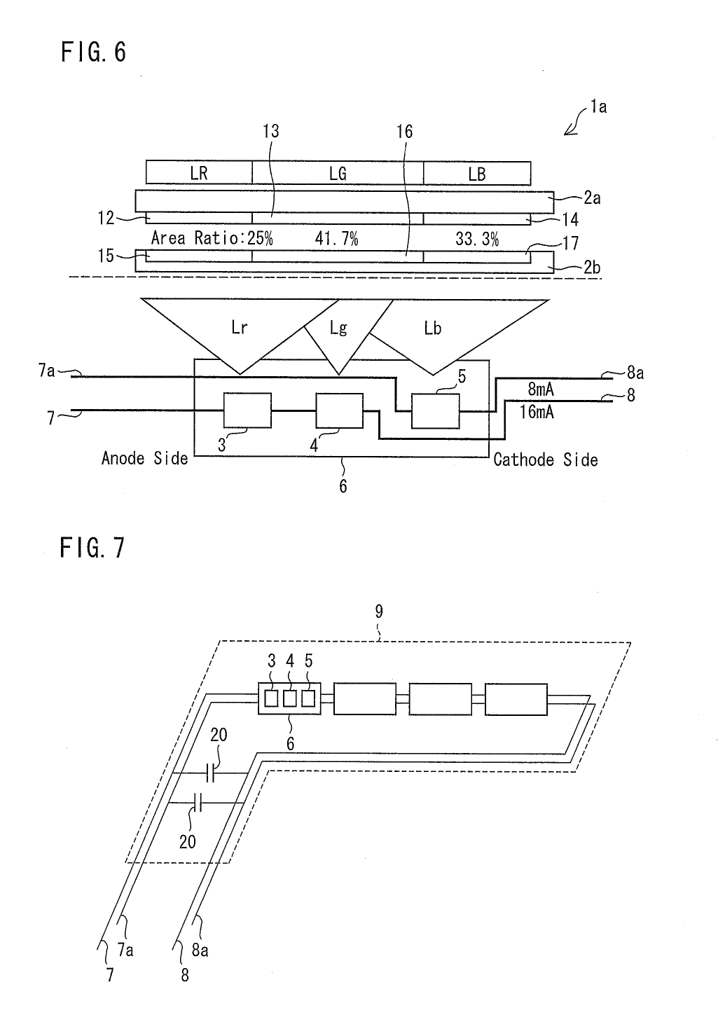

FIG. 6 is a schematic view illustrating a cross section of a liquid crystal display panel 2 and a configuration of an LED group 6, included in the liquid crystal display device 1a shown in FIG. 5.

In the LED group 6, a wire, which is made up of current supply lines 7 and 8, is provided for the red LED 3 and the green LED 4, and a wire, which is made up of current supply lines 7a and 8a, is provided for the blue LED 5 (see FIGS. 5 and 6).

In other words, the two wires, each of which is made up of the current supply lines, are provided for the LED group 6.

In the liquid crystal display device la of the present embodiment, an electric current of 16 mA is applied to the red LED 3 and the green LED 4 via the wire made up of the current supply lines 7 and 8, and an electric current of 8 mA is applied to the blue LED 5 via the wire made up of the current supply lines 7a and 8a.

It is preferable that the electric current (16 mA), which is applied to the red LED 3 and the green LED 4 via the wire made up of the current supply lines 7 and 8, is equal to an average of two electric currents, which are applied to the respective red LED 203 and green LED 204, of the three electric currents (i.e., red: 12 mA, green: 20 mA, and blue: 8 mA), which are applied to the respective LEDs 203, 204, and 205. This is because the conventional liquid crystal display device 201 (see (b) of FIG. 1) shows the desired whiteness ((x, y)=(0.313, 0.329)).

With the configuration, it is possible to obtain the desired white light (whiteness) without significantly altering the configuration (such as one illustrated in (b) of FIG. 1) in which the opening parts have identical area ratios and the color filter layers have identical area ratios.

With regard to red light, the electric current (16 mA), which is applied to the red LED 3 provided in the liquid crystal display device 1a, is larger than the electric current (12 mA) which is applied to the red LED 203 provided in the conventional liquid crystal display device 201. In order to address this, the red color filter layer 12 and the pixel 15 in the liquid crystal display device 1a are configured such that an amount of the red light is decreased (i.e., the area ratio is decreased from 33.3% to 25%).

With regard to green light, the electric current (16 mA), which is applied to the green LED 4 provided in the liquid crystal display device 1a, is smaller than the electric current (20 mA) which is applied to the green LED 204 provided in the conventional liquid crystal display device 201. In order to address this, the green color filter layer 13 and the pixel 16 in the liquid crystal display device 1a are configured such that an amount of the green light is increased (i.e., the area ratio is increased from 33.3% to 41.7%). With regard to blue light, the electric current (8 mA), which is applied to the blue LED 5 provided in the liquid crystal display device 1a, is identical to the electric current (8 mA) which is applied to the blue LED 205 provided in the conventional liquid crystal display device 201. In view of this, the blue color filter layer 14 and the pixel 17 in the liquid crystal display device 1a are configured so that an amount of the blue light is not changed (i.e., the area ratio 33.3% is not changed). This allows the liquid crystal display device 1a to achieve the whiteness ((x, y)=(0.313, 0.329)).

With the configuration, it is possible to reduce, by one (1), the number of the wires each of which is made up of the current supply lines via each of which an electric current is applied to the LED group 6, as compared with the conventional configuration in which the three wires, each of which is made up of the current supply lines, are required for independently controlling the electric currents which are applied to the respective colors of LEDs. This allows a simplification of the wiring on the FPCB 9 and a reduction in width of the FPCB 9. It is therefore possible to reduce cost of the device.

Conventionally, it has been necessary to provide a special LED control circuit which controls the LEDs 3, 4, and 5 separately by applying three separate electric currents to the respective LEDs 3, 4, and 5. On the other hand, the configuration of the present embodiment employs an LED control circuit 19a which controls two electric currents and accordingly has a configuration simpler than the conventionally used special LED control circuit. It is therefore possible to reduce cost of the liquid crystal display device 1a.

The liquid crystal display device 1a employs a connector 18 which has the fewer number of terminals arranged at greater intervals, as compared with the conventional liquid crystal device. This allows a reduction in cost and an improvement in workability.

FIG. 7 illustrates the FPCB 9 on which the LED groups 6 are provided in the liquid crystal display device 1a in which electrostatic protection circuits 20 are provided.

In the liquid crystal display device 1a, an electrostatic protection circuit 20 is provided between the current supply line 7 (i.e., a current inflow side) and the current supply line 8 (i.e., a current outflow side) which are provided for the red LED 3 and the green LED 4 (see FIG. 7). Further, another electrostatic protection circuit 20 is provided between the current supply line 7a (i.e., a current inflow side) and the current supply line 8a (i.e., a current outflow side) which are provided for the blue LED 5 (see FIG. 7).

With the configuration, the number of the electrostatic protection circuits 20 can be reduced, as compared with the conventional configuration. It is therefore possible to reduce cost of the device and improve productivity.

### Embodiment 3

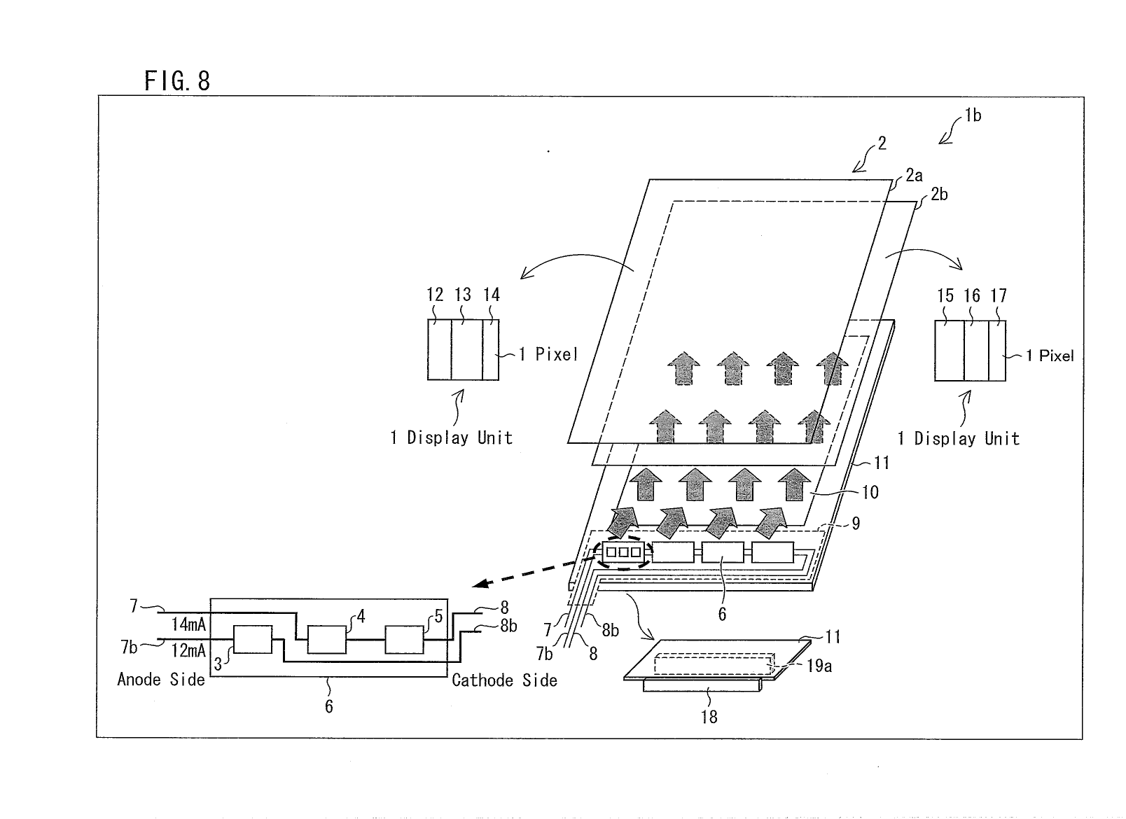

The following describes Embodiment 3 of the present invention, with reference to FIGS. 8 through 10. In Embodiment 3, two of LEDs 3, 4, and 5, which constitute an LED group 6, are connected in series. Specifically, the green LED 4 and the blue LED 5 are connected in series by a wire, which is made up of current supply lines 7 and 8, so that a common electric current is applied to the LEDs 4 and 5. The other arrangements in Embodiment 3 are identical to those in Embodiment 1. For convenience, the same reference numerals are given to constituent members having functions identical to those described in Embodiment 1 with reference to the drawings, and descriptions of such constituent members are omitted.

FIG. 8 is a block diagram illustrating a schematic configuration of a liquid crystal display device 1b in accordance with the present embodiment.

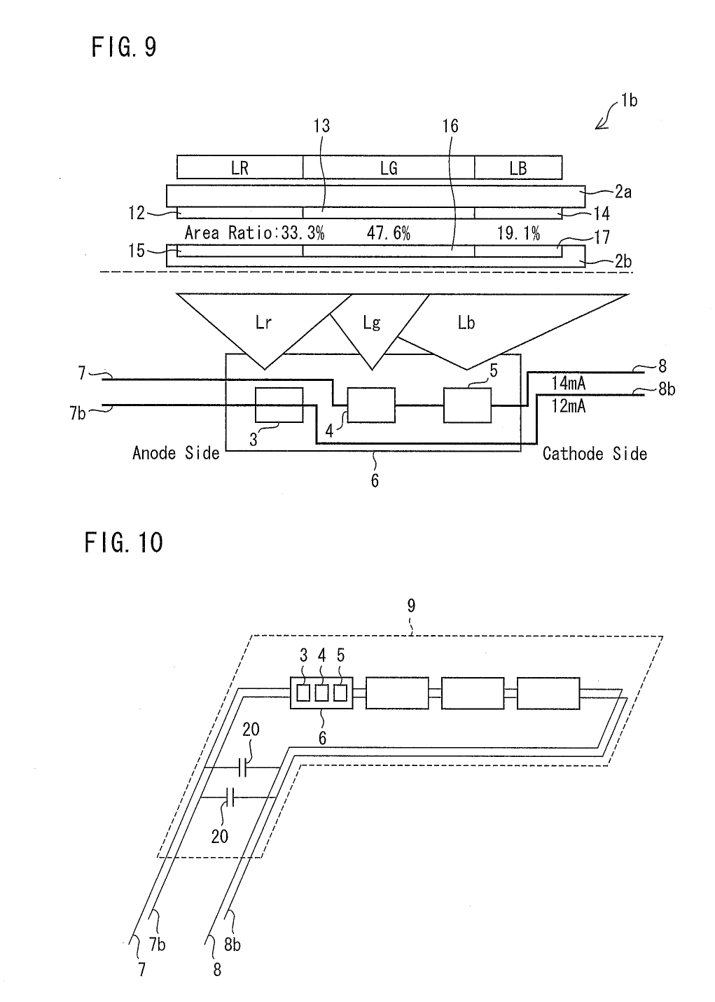

FIG. 9 is a schematic view illustrating a cross section of a liquid crystal display panel 2 and a configuration of an LED group 6, included in the liquid crystal display device 1b shown in FIG. 8.

In the LED group 6, a wire, which is made up of current supply lines 7 and 8, is provided for the green LED 4 and the blue LED 5, and a wire, which is made up of current supply lines 7b and 8b, is provided for the red LED 3 (see FIGS. 8 and 9).

In other words, the two wires, each of which is made up of the current supply lines, are provided for the LED group 6.

In the liquid crystal display device 1b of the present embodiment, an electric current of 14 mA is applied to the green LED 4 and the blue LED 5 via the wire made up of the current supply lines 7 and 8, and an electric current of 12 mA is applied to the red LED 3 via the wire made up of the current supply lines 7b and 8b.

It is preferable that the electric current (14 mA), which is applied to the green LED 4 and the blue LED 5 via the wire made up of the current supply lines 7 and 8, is equal to an average of two electric currents, which are applied to the respective green LED 204 and blue LED 205, of the three electric currents (red: 12 mA, green: 20 mA, and blue: 8 mA), which are applied to the respective LEDs 203, 204, and 205. This is because the conventional liquid crystal display device 201 (see (b) of FIG. 1) shows the desired whiteness ((x, y)=(0.313, 0.329)).

With the configuration, it is possible to obtain the desired white light (whiteness) without significantly altering the configuration (such as one illustrated in (b) of FIG. 1) in which the opening parts have identical area ratios and the color filter layers have identical area ratios.

With regard to red light, the electric current (12 mA), which is applied to the red LED 3 provided in the liquid crystal display device 1b, is identical to the electric current (12 mA) which is applied to the red LED 203 provided in the conventional liquid crystal display device 201. In view of this, the red color filter layer 12 and the pixel 15 in the liquid crystal display device 1b are configured such that an amount of the red light is not changed (i.e., the area ratio 33.3% is not changed).

With regard to green light, the electric current (14 mA), which is applied to the green LED 4 provided in the liquid crystal display device 1b, is smaller than the electric current (20 mA) which is applied to the green LED 204 provided in the conventional liquid crystal display device 201. In order to address this, the green color filter layer 13 and the pixel 16 in the liquid crystal display device 1b are configured such that an amount of the green light is increased (i.e., the area ratio is increased from 33.3% to 47.6%). With regard to blue light, the electric current (14 mA), which is applied to the blue LED 5 provided in the liquid crystal display device 1b, is larger than the electric current (8 mA) which is applied to the blue LED 205 provided in the conventional liquid crystal display device 201. In order to address this, the blue color filter layer 14 and the pixel 17 in the liquid crystal display device 1b are configured such that an amount of the blue light is decreased (i.e., the area ratio is decreased from 33.3% to 19.1%). This allows the liquid crystal display device 1b to achieve the whiteness ((x, y)=(0.313, 0.329)).

FIG. 10 illustrates the FPCB 9 on which the LED groups 6 are provided in the liquid crystal display device 1b in which electrostatic protection circuits 20 are provided.

In the liquid crystal display device 1b, an electrostatic protection circuit 20 is provided between the current supply line 7 (i.e., a current inflow side) and the current supply line 8 (i.e., a current outflow side) which are provided for the green LED 4 and the blue LED 5 (see FIG. 10). Further, another electrostatic protection circuit 20 is provided between the current supply line 7b (i.e., the current inflow side) and the current supply line 8b (i.e., the current outflow side) which are provided for the red LED 3 (see FIG. 10).

Note that an effect brought about by Embodiment 3 is identical to that of Embodiment 2 above described. Descriptions of the effect are therefore omitted here.

### Embodiment 4

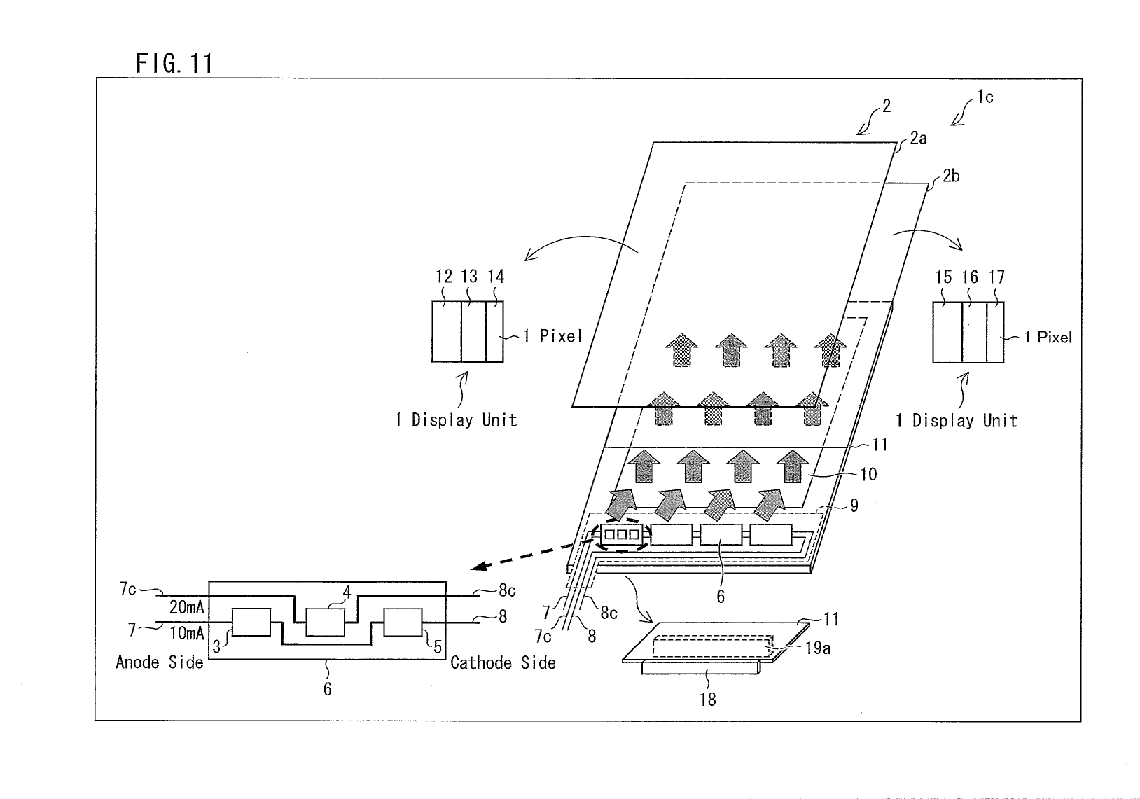

The following describes Embodiment 4 of the present invention, with reference to FIGS. 11 through 13. In Embodiment 4, two of LEDs 3, 4, and 5, which constitute an LED group 6, are connected in series. Specifically, the red LED 3 and the blue LED 5 are connected in series by a wire, which is made up of current supply lines 7 and 8, so that a common electric current are applied to the LEDs 3 and 5. The other arrangements in Embodiment 4 are identical to those in Embodiment 1. For convenience, the same reference numerals are given to constituent members having functions identical to those described in Embodiment 1 with reference to the drawings, and descriptions of such constituent members are omitted.

FIG. 11 is a block diagram illustrating a schematic configuration of a liquid crystal display device 1c in accordance with the present embodiment.

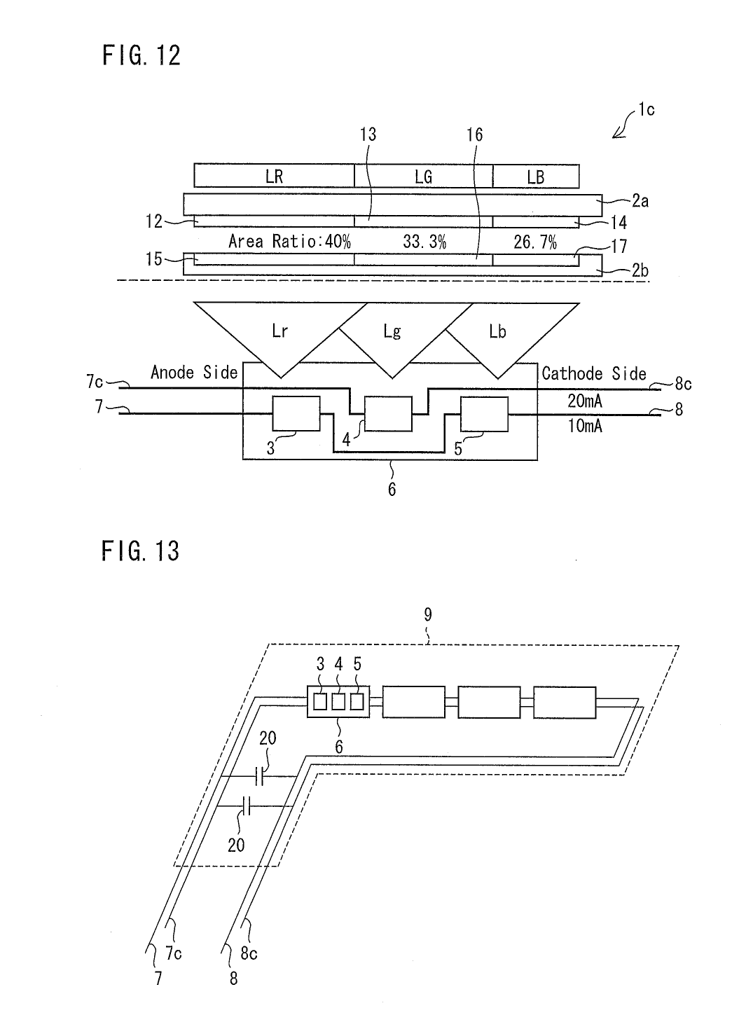

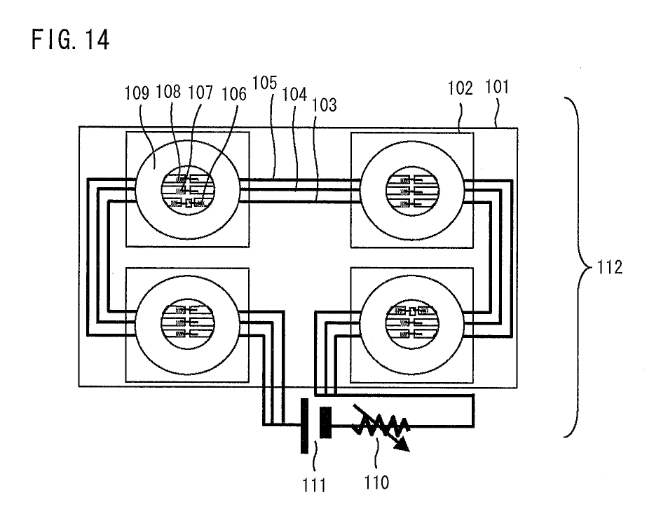

FIG. 12 is a schematic view illustrating a cross section of a liquid crystal display panel 2 and a configuration of an LED group 6, included in the liquid crystal display device 1c shown in FIG. 11.

In the LED group 6, a wire, which is made up of current supply lines 7 and 8, is provided for the red LED 3 and the blue LED 5, and a wire, which is made up of current supply lines 7c and 8c, is provided for the green LED 4 (see FIGS. 11 and 12).

In other words, the two wires, each of which is made up of the current supply lines, are provided for the LED group 6.

In the liquid crystal display device 1c of the present embodiment, an electric current of 10 mA is applied to the red LED 3 and the blue LED 5 via the wire made up of the current supply lines 7 and 8, and an electric current of 20 mA is applied to the green LED 4 via the wire made up of the current supply lines 7c and 8c.

It is preferable that the electric current (10 mA), which is applied to the red LED 3 and the blue LED 5 via the wire made up of the current supply lines 7 and 8, is equal to an average of two electric currents, which are applied to the respective red LED 203 and blue LED 205, of the three electric currents (red: 12 mA, green: 20 mA, and blue: 8 mA), which are applied to the respective LEDs 203, 204, and 205. This is because the conventional liquid crystal display device 201 (see (b) of FIG. 1) shows the desired whiteness ((x, y)=(0.313, 0.329)).

With the configuration, it is possible to obtain the desired white light (whiteness) without significantly altering the configuration (such as one illustrated in (b) of FIG. 1) in which the opening parts have identical area ratios and the color filter layers have identical area ratios.

With regard to red light, the electric current (10 mA), which is applied to the red LED 3 provided in the liquid crystal display device 1c, is smaller than the electric current (12 mA) which is applied to the red LED 203 provided in the conventional liquid crystal display device 201. In order to address this, the red color filter layer 12 and the pixel 15 in the liquid crystal display device 1c are configured such that an amount of the red light is increased (i.e., the area ratio is increased from 33.3% to 40%).

With regard to green light, the electric current (20 mA), which is applied to the green LED 4 provided in the liquid crystal display device 1c, is identical to the electric current (20 mA) which is applied to the green LED 204 provided in the conventional liquid crystal display device 201. In view of this, the green color filter layer 13 and the pixel 16 in the liquid crystal display device 1c are configured such that an amount of the green light is not changed (i.e., the area ratio 33.3% is not changed). With regard to blue light, the electric current (10 mA), which is applied to the blue LED 5 provided in the liquid crystal display device 1c, is larger than the electric current (8 mA) which is applied to the blue LED 205 provided in the conventional liquid crystal display device 201. In order to address this, the blue color filter layer 14 and the pixel 17 in the liquid crystal display device 1c are configured such that an amount of the blue light is decreased (i.e., the area ratio is decreased from 33.3% to 26.7%). This allows the liquid crystal display device lb to achieve the whiteness ((x, y)=(0.313, 0.329)).

FIG. 13 illustrates the FPCB 9 on which the LED groups 6 are provided in the liquid crystal display device 1c in which electrostatic protection circuits 20 are provided.

In the liquid crystal display device 1c, an electrostatic protection circuit 20 is provided between the current supply line 7 (i.e., the current inflow side) and the current supply line 8 (i.e., the current outflow side) which are provided for the red LED 3 and the blue LED 5 (see FIG. 13). Further, another electrostatic protection circuit 20 is provided between the current supply line 7c (i.e., the current inflow side) and the current supply line 8c (i.e., the current outflow side) which are provided for the green LED 4 (see FIG. 13).

Note that an effect brought about by Embodiment 4 is identical to that of Embodiment 2 early described. Descriptions of the effect are therefore omitted here.

According to the display device of the present invention, it is preferable that the at least two colors of the light-emitting elements are connected in series via a single wire so that the single current is applied to the plurality of light-emitting elements.

According to the display device of the present invention, it is preferable that the opening parts of the respective at least two pixels have identical area ratios and the at least two color filter layers have identical area ratios.

According to the configuration, the desired white light can be generated by adjusting the thickness of each of the at least two color filter layers, even though the opening parts of the respective colors have identical area ratios and the at least two color filter layers, which correspond to the respective pixels, have identical area ratios.

According to the display device of the present invention, it is preferable that, in a case where (i) the area ratios of the opening parts of the respective at least two pixels are identical, (ii) the area ratios of the respective at least two color filter layers are identical, in the at least two light emitting elements, and (iii), when predetermined different electric currents are applied to the at least two light emitting elements, the at least two light emitting elements have respective predetermined emission amounts, (a) the first and second area ratios, (b) the first area ratio and the thickness, or (c) the first and second area ratios and the thickness are set so that the at least two light emitting elements have the respective predetermined emission amounts.

According to the configuration, the electric current, which is the average of the different predetermined electric currents, is applied to the at least two colors of light-emitting elements via the wire so that the predetermined emission amounts of the respective at least two colors are obtained. This makes it possible to obtain desired white light (whiteness) only by altering, not so significantly, the area ratio of the opening part of each of the at least two colors and the area ratio and/or thickness of each of the at least two colors of light-emitting elements.

According to the display device of the present invention, it is preferable that the first area ratios of the opening parts of the respective at least two pixels are identical to the second area ratios of the respective at least two color filter layers.

According to the configuration, the area ratios of the respective at least two color filter layers, based on which amounts of respective colors of light emitted from the display device are determined, are set to be identical to the area ratios of the opening parts of the corresponding colors of the pixels. This makes it possible to simplify the configurations of the pixels and the at least two color filter layers. Further, it is possible to obtain desired white light by changing, while facilitating the design of area ratios, the amounts of respective colors of light emitted from the display device.

According to the display device of the present invention, it is preferable that the at least two colors are red, green, and blue.

With the configuration, the light-emitting element group of the present invention can be configured by widely used three colors of LEDs.

According to the display device of the present invention, it is preferable that the plurality of light-emitting element groups are provided on a flexible printed circuit board.

In general, medium and small sized liquid crystal display devices have a spatial limitation. As such, a degree of freedom is improved in arrangement of constituent members of such medium and small sized liquid crystal display devices, by using a flexible printed circuit board.

With the configuration of the present invention, it is possible to (i) simplify wiring on the flexible printed circuit board on which the light-emitting element group is mounted and (ii) reduce a width of the flexible printed circuit board. This allows a reduction in area of an outer frame which is a non-display area, in particular, in medium and small sized liquid crystal display devices. As such, it is possible to provide a compact liquid crystal display device.

According to the display device of the present invention, it is preferable that the wire has a current inflow side part and a current outflow side part between which an electrostatic protection circuit is provided.

With the configuration, it is possible to prevent the light-emitting elements from being broken by externally applied static electricity and a noise current.

According to a conventional configuration, it has been necessary to provide three wires for applying separate electric currents to respective light-emitting elements. Accordingly, it has been necessary to provide three electrostatic protection circuits for the respective three wires.

On the other hand, with the configuration of the present invention, it is possible to reduce the number of an electrostatic protection circuit, as compared with the conventional configuration. This allows a reduction in cost and an improvement in productivity.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention is applicable to a display device including a backlight in which a light-emitting element is provided as a light source.

### REFERENCE SIGNS LIST

1, 1a, 1b, and 1c: Liquid crystal display device (display device)
3: Red LED (light-emitting element)
4: Green LED (light-emitting element)
5: Blue LED (light-emitting element)
6: LED group (light-emitting element group)
7, 7a, 7b, and 7c: Current supply line (wire)
8, 8a, 8b, and 8c: Current supply line (wire)
9: FPCB (Flexible printed circuit board)
12: Red color filter layer (color filter layer)
13: Green color filter layer (color filter layer)
14: Blue color filter layer (color filter layer)
15: Pixel corresponding to red color filter layer
16: Pixel corresponding to green color filter layer
17: Pixel corresponding to blue color filter layer
18: Connector
19 and 19a: LED control circuit
20: Electrostatic protection circuit
Lr, Lg, and Lb: Light emitted by LEDs of respective colors
LR, LG, and LB: Light of each color emitted by liquid crystal display device

1. A display device which displays an image by modulating an amount of transmitting light in accordance with an image signal, said display device comprising:
a plurality of light-emitting element groups each made up of at least two colors of light-emitting elements so that white light is generated, the light-emitting element group serving as a light source of said display device;
at least two color filter layers for the respective at least two colors; and
at least two pixels provided for the respective at least two colors, each of the at least two pixels having an opening part,
said at least two colors of light-emitting elements being connected in series so as to receive a single electric current via a wire, and
(i) a first area ratio of the opening part of each of the at least two pixels and (ii) a second area ratio of each of the at least two color filter layers for the respective at least two pixels are set so that the white light is generated.

2. A display device which displays an image by modulating an amount of transmitting light in accordance with an image signal, said display device comprising:
a plurality of light-emitting element groups each made up of at least two colors of light-emitting elements so that white light is generated, the light-emitting element group serving as a light source of said display device;
at least two color filter layers for the respective at least two colors; and
at least two pixels provided for the respective at least two colors, each of the at least two pixels having an opening part,
said at least two colors of light-emitting elements being connected in series so as to receive a single electric current via a wire, and
(i) a first area ratio of the opening part of each of the at least two pixels and (ii) a thickness of each of the at least two color filter layers for the respective at least two pixels are set so that the white light is generated.

3. The display device as set forth in claim 2, wherein:
the opening parts of the respective at least two pixels have identical area ratios and the at least two color filter layers have identical area ratios.

4. A display device which displays an image by modulating an amount of transmitting light in accordance with an image signal, said display device comprising:
a plurality of light-emitting element groups each made up of at least two colors of light-emitting elements so that white light is generated, the light-emitting element group serving as a light source of said display device;
at least two color filter layers for the respective at least two colors; and
at least two pixels provided for the respective at least two colors, each of the at least two pixels having an opening part,
said at least two colors of light-emitting elements being connected in series so as to receive a single electric current via a wire, and
(i) a first area ratio of the opening part of each of the at least two pixels and (ii) a second area ratio of and a thickness of each of the at least two color filter layers for the respective at least two pixels are set so that the white light is generated.

5. The display device as set forth in claim 1, wherein the wire is a single wire.

6. The display device as set forth in claim 1, wherein:
in a case where (i) the area ratios of the opening parts of the respective at least two pixels are identical, (ii) the area ratios of the respective at least two color filter layers are identical, in said at least two light emitting elements, and (iii), when predetermined different electric currents are applied to said at least two light emitting elements, said at least two light emitting elements have respective predetermined emission amounts, (a) the first and second area ratios, (b) the first area ratio and the thickness, or (c) the first and second area ratios and the thickness are set so that said at least two light emitting elements have the respective predetermined emission amounts.

7. The display device as set forth in claim 1, wherein:
the first area ratios of the opening parts of the respective at least two pixels are identical to the second area ratios of the respective at least two color filter layers.

8. The display device as set forth in claim 1, wherein:
the at least two colors are red, green, and blue.

9. The display device as set forth in claim 1, wherein:
the plurality of light-emitting element groups are provided on a flexible printed circuit board.

10. The display device as set forth in claim 1, wherein:
the wire has a current inflow side part and a current outflow side part between which an electrostatic protection circuit is provided.

11. The display device as set forth in claim 2, wherein the wire is a single wire.

12. The display device as set forth in claim 4, wherein the wire is a single wire.

13. The display device as set forth in claim 2, wherein:
in a case where (i) the area ratios of the opening parts of the respective at least two pixels are identical, (ii) the area ratios of the respective at least two color filter layers are identical, in said at least two light emitting elements, and (iii), when predetermined different electric currents are applied to said at least two light emitting elements, said at least two light emitting elements have respective predetermined emission amounts, (a) the first and second area ratios, (b) the first area ratio and the thickness, or (c) the first and second area ratios and the thickness are set so that said at least two light emitting elements have the respective predetermined emission amounts.

14. The display device as set forth in claim 4, wherein:
in a case where (i) the area ratios of the opening parts of the respective at least two pixels are identical, (ii) the area ratios of the respective at least two color filter layers are identical, in said at least two light emitting elements, and (iii), when predetermined different electric currents are applied to said at least two light emitting elements, said at least two light emitting elements have respective predetermined emission amounts, (a) the first and second area ratios, (b) the first area ratio and the thickness, or (c) the first and second area ratios and the thickness are set so that said at least two light emitting elements have the respective predetermined emission amounts.

15. The display device as set forth in claim 2, wherein:
the first area ratios of the opening parts of the respective at least two pixels are identical to the second area ratios of the respective at least two color filter layers.

16. The display device as set forth in claim 4, wherein:
the first area ratios of the opening parts of the respective at least two pixels are identical to the second area ratios of the respective at least two color filter layers.

17. The display device as set forth in claim 2, wherein:
the at least two colors are red, green, and blue.

18. The display device as set forth in claim 4, wherein:
the at least two colors are red, green, and blue.

19. The display device as set forth in claim 2, wherein:
the plurality of light-emitting element groups are provided on a flexible printed circuit board.

20. The display device as set forth in claim 4, wherein:
the plurality of light-emitting element groups are provided on a flexible printed circuit board.

21. The display device as set forth in claim 2, wherein:
the wire has a current inflow side part and a current outflow side part between which an electrostatic protection circuit is provided.

22. The display device as set forth in claim 4, wherein:
the wire has a current inflow side part and a current outflow side part between which an electrostatic protection circuit is provided.
